(19) United States
(12) Patent Application Publication
(10) Pub. No.: US 2019/0173414 A1
(43) Pub. Date: Jun. 6, 2019

(54) Prediction Method for Reliability Degree of Running Temperature Rise of a Large and Medium-sized Motor

(71) Applicant: YANGZHOU UNIVERSITY, Yangzhou (CN)

(72) Inventors: Baoyun Qiu, Yangzhou (CN); Mengfan Xu, Yangzhou (CN); Xia Lu, Yangzhou (CN); Qiang Guo, Yangzhou (CN); Liming Tang, Yangzhou (CN); Chenglong Xue, Yangzhou (CN); Cai Zhang, Yangzhou (CN); Di Liu, Yangzhou (CN); Fangling Zhao, Yangzhou (CN)

(21) Appl. No.: 16/258,608

(22) Filed: Jan. 27, 2019

(30) Foreign Application Priority Data
Jan. 29, 2018 (CN) 201810081395.0

(51) Int. Cl. H02P 29/64

(52) U.S. Cl. CPC H02P 29/64

(57) ABSTRACT

A prediction method for reliability degree of running temperature rise of a large and medium-sized motor belongs to the technical field of reliability and durability of electromechanical power equipment, and includes determining main influence factors of the temperature rise of a motor winding, calculating the heating quantity and the temperature rise of the motor under influences of the determined factors, determining random numerical characteristics of the main influence factors of the temperature rise of the motor winding, calculating and determining possible minimum values and possible maximum values of running temperatures of the motor winding under different environment temperatures, calculating and determining reliability degrees when the running temperature of the motor winding is less than a given temperature under different environment temperatures, and calculating and determining the reliability degree of the running temperature rise of the motor winding.

### TECHNICAL FIELD

The present invention belongs to the technical field of reliability and durability of electromechanical power equipment, relates to a prediction method for a reliability degree of a running temperature rise of a large and medium-sized motor, and more particularly relates to a prediction method for a reliability degree of a running temperature rise of a motor considering uncertainties of influence factors such as a running work condition, a power supply voltage, motor structures, heat transfer properties and a cooling ventilation flow rate.

### BACKGROUND ART

Lots of heat will be generated due to existence of various energy losses in the running process of a motor, which results in that temperatures of various portions in the motor rise. If the heat cannot be discharged out in time, a motor temperature would continuously rise, if a motor corresponding to a certain insulation grade exceeds the allowable highest temperature, the motor insulation would accelerate ageing, even a direct breakdown is caused, an accident is caused, losses are caused, and safe and reliable running of the motor will be greatly influenced. Thus, an effective cooling measure must be taken for the motor to control a temperature rise of the motor. In the motor, temperature of a stator winding is highest, and when the motor is researched, commonly a temperature rise of the stator winding represents the temperature rise of the motor. Motors in different insulation grades are different in the allowable highest temperature. Currently, for a large and medium-sized direct-transmission water pump unit, due to the fact that a motor is large in volume, a ventilation duct is arranged in the motor, a heating density is not large, and a running temperature of the motor is commonly controlled by adopting a ventilation cooling method. However, the motor is designed according to determined factors, that is, under influences of various determined factors of a designed work condition and a designed running condition, it is guaranteed that a running temperature of the motor winding is free of overtemperature. But due to the fact that factors influencing the motor temperature rise in an actual condition are complicated, uncertainty exists, which results in that the motor temperature rise deviates from a design value, and overtemperature occurs frequently, safety and reliability of the motor are affected, difficulty is brought to design, selection and use of the motor and selection of a ventilator, and it is urgently needed to invent a prediction method, considering the uncertainties of the influence factors of the motor temperature rise, for a reliability degree of the motor temperature rise.

### SUMMARY OF THE INVENTION

The present invention is directed to a prediction method for a reliability degree of a running temperature rise of a large and medium-sized motor in view of the above problem that uncertainty of the motor temperature rise is caused due to uncertainties of various influence factors of the temperature rise, namely a method for a reliability degree when a motor stator winding temperature does not exceed the allowable highest temperature. Main influence factors, including motor running power, power network voltage fluctuation, a winding insulation thickness, ventilation slot heat exchange areas and a ventilation flow rate, of a motor winding temperature rise are determined, then a temperature rise influence value range and a probability density of each factor are calculated, all the influence factors are composited, reliability degrees are calculated when an actual running temperature of the motor is lower than or equal to different temperatures, according to a given allowable highest running temperature of the motor, motor temperature rise reliability degrees under different environment temperatures are calculated and determined, safety of running of the motor may be guaranteed, and a more scientific basis is provided for improved design, reasonable selection and running management of the motor and a ventilation system thereof.

A technical scheme of the present invention is that: the prediction method for the reliability degree of the running temperature rise of the large and medium-sized motor includes following operation steps:

A. determining main influence factors of a temperature rise of a motor winding;

B. calculating a heating quantity of the motor;

C. calculating temperature rises of the motor winding under different environment temperatures;

D. determining random numerical characteristics of the influence factors of the temperature rise of the motor winding;

E. calculating and determining possible minimum and maximum values of running temperatures of the motor winding under different environment temperatures;

F. a calculation method for the reliability degree when the running temperature of the motor winding is less than a certain given temperature;

G. calculating and determining reliability degrees when the running temperature of the motor winding is less than the given temperature under different environment temperatures; and

H. calculating and determining the reliability degree of the running temperature rise of the motor winding.

In step A, the main influence factors of the temperature rise of the motor winding are determined as follows.

Heat sources of the motor temperature rise include: a winding copper loss, an iron core loss and an excitation loss, and when motor cooling is carried out by adopting a manner of forced ventilation by a draught fan, heat generated due to ventilation friction also needs to be considered. When the motor works, heat is generated due to the motor stator winding copper loss, a winding temperature is higher than an iron core temperature, the heat is transmitted to an iron core through winding insulation; and heat generated due to the iron core loss and the heat transmitted from the winding are subjected to convection heat exchange of cooling air in ventilation ducts, and the generated heat is brought out of the motor.

According to calculation and comparison, the main factors influencing the motor temperature rise include motor running power, power network voltage, the winding insulation layer thickness, the ventilation slot heat exchange area and the ventilation flow rate.

In step B, a calculation method for the heating quantity of the motor is as follows. The heating quantity of the motor mainly comes from the iron core loss, the winding copper loss and the excitation loss. Heat generated by a mechanical loss of a thrust bearing and two guide bearings of the motor is brought away by cooling water in a cooler, and is not reckoned into a ventilation cooling load, wherein the iron core loss may be calculated with a following formula:

$${P}_{Fe} = {K}_{a} {p}_{0} {B}^{2} {{M}_{Fe} ( \frac{f}{50} )}^{1.3} \qquad ( 1 )$$

In the formula: Kₐ—experience coefficient; f-alternating frequency; p₀—loss of per unit mass iron core when f is 50 Hz; B-magnetic flux density; M_{Fe}—mass of the iron core.

A stator winding copper loss may be calculated with a following formula:

P_{cu1}=mm_{c}I₁²r₁ (2)

In the formula: m-motor phase number; m_{c}—insulation temperature rise coefficient, 1.4 is selected for Grade B insulation, and 1.48 is selected for Grade F insulation; I₁—phase current; and r₁—phase resistance:

A synchronous motor excitation winding copper loss may be calculated with a following formula:

P_{Cu2}=I₂²r₂ (3)

In the formula: I₂—excitation current; and r₂—excitation winding resistance.

The motor adopts the draught fan for ventilation, the draught fan sucks hot air from the motor, the hot air is discharged into atmosphere, negative pressure in the motor is caused, outside cold air is forced to enter the ventilation duct in the motor, and after heat is absorbed, the cold air is discharged into the atmosphere by the draught fan. A full air pressure generated due to ventilation of the draught fan is fully lost on ventilation loop resistance, and is converted into heat, and the heat is also brought away by ventilation, that is ventilation friction resistance loss power is:

P_{V}= [symbol] p (4)

In the formula: [symbol] —ventilation flow rate; and p—full pressure loss generated in a process that air passes through the motor during motor ventilation.

In step C, a calculation method for the temperature rises of the motor winding under different environment temperatures is as follows.

Firstly, resistance coefficients of various portions of the ventilation duct and a ventilation loop of the motor are calculated, and the flow rate of the draught fan at an actual work condition point is determined according to a flow rate-full pressure performance curve of the draught fan matched for use and a required pressure curve of the ventilation system; then according to air duct arrangement, an actual air velocity in each segment of the ventilation duct is determined; and a heat exchange coefficient of a heat exchange surface is obtained from the air velocity, and then is substituted into a temperature rise calculation formula, and the motor temperature rise under a certain environment temperature is obtained.

Specific calculation formulae are as follows.

A friction pressure loss is:

$$Δ {p}_{f} = {\sum }_{i = 1}^{m} {λ}_{i} \frac{{l}_{i}}{{d}_{i}} \frac{ρ}{2} {v}_{i}^{2} = {\sum }_{i = 1}^{m} {λ}_{i} \frac{{l}_{i}}{{d}_{i}} \frac{ρ}{2 {A}_{i}^{2}} {Q}^{2} \qquad ( 5 )$$

In the formula, i—serial number of a friction loss of the ventilation loop; m—sum of the friction losses of the ventilation loop; λ—friction resistance coefficient; l—flow channel length; d—flow channel equivalent diameter, and when a flow channel is a rectangular pipeline,

$$d = \frac{2 hb}{h + b} ;$$

h—height of a section of the rectangular pipeline; b—breadth of the section of the rectangular pipeline; p—density of air; v—air velocity;
A—area of a cross section of the flow channel; and [symbol] —flow rate of ventilation.

A local pressure loss is:

$$Δ {p}_{j} = {\sum }_{j = 1}^{n} {ζ}_{j} \frac{ρ}{2} {v}_{j}^{2} = {\sum }_{j = 1}^{n} \frac{{ζ}_{j} ρ}{2 {A}_{j}^{2}} {Q}^{2} \qquad ( 6 )$$

In the formula: j—serial number of a local resistance; n—local resistance sum; and ζ—local loss coefficient.

An equivalent air resistance of an air course formed by n air resistances connected in series is:

$$Z = {\sum }_{i = 1}^{n} {Z}_{i} \qquad ( 7 )$$

An equivalent air resistance of an air course formed by n air resistances connected in parallel is:

$$Z = \frac{1}{{( {\sum }_{i = 1}^{n} \frac{1}{\sqrt{{Z}_{i}}} )}^{2}} \qquad ( 8 )$$

A total area of stator ventilation slots is:

S₃π(D₁+D₂)h (9)

In the formula, hₙ—slot height, bₙ—slot breadth; l₁—stator iron core length; and z₁—stator ventilation slot number.

A total area of ventilation openings of the stator iron core is:

S₂=z₁bₙhₙ (10)

A total area of inner and outer cylindrical surfaces of the stator iron core is:

S₃=π(D₁+D₂)h (11)

In the formula: D₁—outer circle diameter of the stator iron core; D₂—inner circle diameter of the stator iron core; and h-height of the stator iron core;

A total heat dissipating area of the station iron core is:

S_{Fe}=S₁+S₃−2S₂ (12)

A contact area of the stator winding and the iron core is:

S₄=n₁L₁h₁ (13)

In the formula: n₁—winding branch number; L₁—perimeter of a contact surface of the winding and the iron core; and h₁—length of the contact surface of the winding and the iron core

An average air velocity in an air duct is:

v= [symbol] /s (14)

In the formula: s-sectional area of the air duct.

A radial ventilation slot surface heat exchange coefficient:

$$α = \frac{1 + 0.24 v}{0.045} \qquad ( 15 )$$

The winding temperature rise is:

$$\begin{matrix}{t}_{m} = Δ {t}_{1} + Δ {t}_{Fe 1} + Δ {t}_{Fea} + Δ {t}_{a} \\ = \frac{{ϕ}_{CF} {P}_{Cu 1} δ}{{λ}_{1} {S}_{4}} + \frac{{qL}_{Fe 1}^{2}}{12 {k}_{Fe}} + \frac{{P}_{1}}{α {S}_{Fe}} + \frac{\sum P}{CQ} \\ = \frac{{ϕ}_{CF} {P}_{Cu 1} δ}{{λ}_{1} {S}_{4}} + \frac{( {P}_{Fe} + {ϕ}_{CF} {P}_{Cu 1} ) {L}_{Fe 1}^{2}}{12 {k}_{Fe} {S}_{1}} + \\ \frac{{P}_{Fe} + {ϕ}_{CF} ( {P}_{Cu 1} + {P}_{Cu 2} )}{α {S}_{Fe}} + \frac{\sum P}{{C}_{a} Q}\end{matrix} \qquad ( 16 )$$

In the formula: Δt₁—winding insulation layer temperature drop; Δt_{Fe1}—iron core interior average temperature difference; Δt_{Fea}—temperature difference between a surface of an iron core segment and air; Δtₐ—air temperature rise; φ_{CF}—loss component transmitted to the iron core from copper; q—unit volume heat flowing in axis direction of the iron core; L_{Fe1}—iron core length; P₁—loss dissipated through the iron core; λ₁—winding insulation heat conduction coefficient, the insulation heat conduction coefficient is relevant to temperature, and insulation heat conduction coefficients under different environment temperatures are obtained through an iterative approximation method; k_{Fe}—coefficient; α—surface heat exchange coefficient of ventilation slot; ΣP—total heating quantity of the motor; Cₐ—air volume specific heat capacity; and [symbol] —ventilation flow rate.

The temperature rises of the motor winding under effects of the determined influence factors and under different environment temperatures are calculated with the formula (16), and by adding an environment temperature, motor running temperatures are obtained, as shown by a curve 1 in FIG. 1.

In step D, a determination method of the random numerical characteristics of the influence factors of the temperature rise of the motor winding is as follows:

Influences of a random error of the motor running power on the motor temperature rise are considered. A ratio of the running power in random change and originally determined running power is relative power δ_{P} of the motor, and a random value range of δ_{P} is [δ_{Pmin}, δ_{Pmax}].

Assuming that motor running efficiency is unchanged, the motor stator and rotor winding copper losses, the iron core loss, the ventilation friction resistance loss and the like are all converted into heat, and according to the temperature rise calculation formula and a relationship between the various types of motor losses and the motor running power, influences of motor power change on the motor temperature rise are calculated as follows:

$$\begin{matrix}Δ {t}_{P} = [ \frac{{L}_{Fe 1}^{2} ( 1 + {ϕ}_{CF} )}{12 {k}_{Fe}} + \frac{1 + {ϕ}_{CF}}{α {S}_{Fe}} + \frac{{ϕ}_{CF} δ}{{λ}_{1} {S}_{4}} + \frac{1}{{C}_{a} Q} ] Δ {P}_{F} \\ = {K}_{P} ( {δ}_{P} - 1 ) = {g}_{1} ( {δ}_{P} )\end{matrix} \qquad ( 17 )$$

In the formula, ΔP_{F}—motor heating quantity change caused by the motor running power change; and K_{P}—power change influence coefficient.

Influences of the power network voltage fluctuation on the motor winding temperature rise are considered. A ratio of a power network voltage in random change and an originally determined power network voltage is a relative voltage δ_{V}, a random value range of δ_{V} is [δ_{Vmin}, δ_{Vmax}], according to the motor temperature rise calculation formula and a relationship between the voltage change and the motor power, an influence value of the relative voltage fluctuation on the motor temperature rise is calculated, and its calculation formula is:

$$\begin{matrix}Δ {t}_{V} = 2 [ ( \frac{{ϕ}_{CF} {L}_{Fe}^{2}}{12 {K}_{Fe} {S}_{1}} + \frac{{ϕ}_{CF}}{α {S}_{Fe}} + \frac{{ϕ}_{CF} δ}{{λ}_{1} {S}_{4}} + \frac{1}{{C}_{a} Q} ) {P}_{Cu 1} + \\ ( \frac{{L}_{Fe}^{2}}{12 {K}_{Fe} {S}_{1}} + \frac{1}{\overline{a} {S}_{Fe}} + \frac{1}{{C}_{a} Q} ) {P}_{Fe} ] {δ}_{V} \\ = {K}_{V} ( {δ}_{V} - 1 ) = {g}_{2} ( {δ}_{V} )\end{matrix} \qquad ( 18 )$$

In the formula, K_{V}—voltage fluctuation influence coefficient.

Influences of the winding insulation layer thickness on the motor winding temperature rise are considered. A ratio of the winding insulation layer thickness in random change and an originally determined winding insulation layer thickness is a winding insulation layer relative thickness δ_{D}, and a random value range of δ_{D} is [δ_{Dmin}, δ_{Dmax}]. It can be known that according to the motor temperature rise calculation formula, the winding insulation layer thickness and the motor winding temperature rise are in a linear relationship, and a calculation formula of an influence value of the winding insulation layer relative thickness on the motor temperature rise is:

$$Δ {t}_{D} = \frac{{ϕ}_{CF} {P}_{Cu 1}}{{λ}_{1} {S}_{4}} {δ}_{m} ( {δ}_{D} - 1 ) = {K}_{D} ( {δ}_{D} - 1 ) = {g}_{3} ( {δ}_{D} ) \qquad ( 19 )$$

In the formula, δₘ—originally determined winding insulation layer thickness; and K_{D}—insulation layer thickness influence coefficient.

It is considered that the ventilation slot heat exchange area has influences on the motor winding temperature rise. A ratio of the ventilation slot heat exchange area in random change and a determined ventilation slot heat exchange area is a ventilation slot relative heat exchange area δ_{A}, and a random value range of δ_{A} is [δ_{Amin}, δ_{Amax}]. According to a maximum value and a minimum value of the ventilation slot relative heat exchange area, a plurality of points are taken between the maximum value and the minimum value, different ventilation slot relative heat exchange areas are substituted into the temperature rise calculation formula, a calculation result is subtracted from a calculation result of the originally determined ventilation slot heat exchange area, and motor temperature rise changes under different δ_{A} are obtained. A curve is fitted according to splattering values, and a calculation formula of the motor temperature rise change Δt_{A} under any δ_{A} is obtained

Δt_{A}==g₄9δ_{A}0 (20)

It is considered that the ventilation flow rate has influences on the motor temperature rise. A ratio of the ventilation flow rate in random change and an originally determined ventilation flow rate is a relative ventilation flow rate [symbol] and a random value range of [symbol] is [symbol] [symbol] . A plurality of points are taken between a largest ventilation flow rate and a smallest ventilation flow rate, different ventilation flow rates are substituted into the temperature rise calculation formula, a calculation result is subtracted from a result of the originally determined ventilation flow rate, and motor temperature rise changes under different [symbol] are obtained. A fitting curve is made according to splattering values, and a calculation formula of the motor temperature rise change [symbol] under [symbol] is obtained

[symbol]

==g₅( [symbol] ) (21)

A probability density function determination method of random changes of relative values of the influence factors is as follows.

According to the random change range [xₘᵢₙ, xₘₐₓ] of the influence factors of the motor winding temperature rise, a probability density function ƒ(x) is determined, a probability density distribution type is parabolic distribution, an opening faces downwards, and a calculation formula is:

ƒ(x)=ax²+bx+c(a≠0) (22)

According to non-negativity of the probability density function, an upper limit and a lower limit of the random change range of the influence factor are substituted in, a probability density value of 0 is obtained, and probability density values of other values in the domain of definition are all larger than 0; and according to normativity of the probability density function, an area surrounded by a probability density function curve and x axis is 1. Specific formulae are as follows:

axₘᵢₙ²+bxₘᵢₙ+c=0 (23)

axₘₐₓ²+bxₘₐₓ+c=0 (24)

∫ₓ_{ₘᵢₙ}^{x}^{ₘₐₓ}ƒ(x)dx=1 (25)

The coefficients a, b and c of the probability density function are solved from the three equations (23), (24) and (25). Corresponding probability density functions are respectively solved for the several types of influence factors of the temperature rise of the motor winding by adopting the method.

In step E, a calculation and determination method of the possible minimum and maximum values of the running temperatures of the motor winding under different environment temperatures is as follows.

A motor running basic temperature under a certain environment temperature and extreme values of decrease or increase, caused by the various random factors, of the temperature rise are accumulated to obtain possible minimum and maximum values of the running temperature of the motor winding under the environment temperature, and a calculation formula is as follows:

t_{Cu1min}=tₐtₘ+Δt_{Pmin}+Δt_{Vmin}+t_{Dmin}+Δt_{Amin}+ [symbol] (26)

t_{Cu1max}=tₐ+tₘ+Δt_{Pmax}+Δt_{Vmax}+Δt_{Dmax}+Δt_{Amax}+ [symbol] (27)

In the formula: tₐ is an environment temperature. Under different environment temperatures, schematic views of the possible lowest and highest running temperatures of the motor winding are respectively as shown by curve 2 and curve 3 in FIG. 1.

In step F, the calculation method for the reliability degree when the running temperature of the motor winding is lower than a certain given temperature is as follows.

The random value ranges and probability density functions of the influence factors of the motor power δ_{P}, the power network voltage δ_{V}, the ventilation flow rate [symbol] , the winding insulation thickness 8D and the ventilation slot heat exchange area δ_{A} are known and the probability density functions of the influence factors are respectively ƒ_{P}(δ_{P}), ƒ_{V}(δ_{V}). [symbol] ( [symbol] ), ƒ_{D}(δ_{D}) and ƒ_{A}(δ_{A}), the reliability degree is calculated when the running temperature of the motor winding is lower than the certain temperature, that is, the running temperature of the motor winding, t=tₐ+tₘ+Δt_{P}+Δt_{V}+ [symbol] +Δt_{D}+Δt_{A}, for a set motor winding temperature t₅ (a subscript 5 shows that five factors are considered), a reliability degree P₅ is calculated when the running temperature of the motor winding t≤t₅. Firstly, two influence factors are composited, a probability P₂ is calculated, and analysis is as follows.

The random value range of a relative value of the first factor motor power is δ_{P}=[δ_{Pmin}, δ_{Pmax}], and the probability density function of the first factor motor power is ƒ_{P}(δ_{P}) as shown in FIG. 2. At any point δ_{P} in a range [δ_{Pmin}, δ_{Pmax}] of an abscissa, a micro-component area ƒ_{P}(δ_{P})dδ_{P} with a micro width being dδ_{P} and a height being ƒ_{P}(δ_{P}) is taken, and the micro-component area is a probability when is valued therein.

A probability P₂ when tₐ+tₘ+Δt_{P}+Δt_{V}≤t₂ is solved, namely a sum of products of all micro area probabilities ƒ_{P}(δ_{P})dδ_{P} and a probability P₁ when tₐ+tₘ+Δt_{V}≤t₂−Δt_{P}=t₁, namely, P₂=∫_{δ}_{_{Pmin}}^{δ}^{_{Pmax}} P₁·ƒ_{P}(δ_{P})dδ_{P}, wherein a probability P₁ when Δt_{V}≤t₁−tₐ−tₘ, namely, δ_{V}≤(t₁−tₐ−tₘ)/K_{V}+1 is an area [symbol] _{V} of a figure on left side of the line δ_{V}=(t₁−tₐ−tₘ)/K_{V}+1 in FIG. 3, then P₂=∫_{δ}_{_{Pmin}}^{δ}^{_{Pmax}} [symbol] _{V}·ƒ_{P}(δ_{P})dδ_{P}, wherein [symbol] _{V}=∫_{δ}_{_{Vmin}}^{(t}^{₁}^{-t}^{ₐ}^{-t}^{ₘ}^{)/K}^{_{V}}⁺¹ ƒ_{V}(δ_{V})dδ_{V}; a [symbol] _{V} expression is substituted into the P₂ calculation formula, and probability when the running temperature of the motor winding is lower than or equal to t₂ may be obtained. Then the third factor, the fourth factor and the fifth factor are considered, recursive integrals continue to be deduced with the same method, and a probability P₅ when the running temperature of the motor winding is lower than or equal to t₅ is finally obtained:

P₅=∫_{δ}_{_{Amin}}^{δ}^{_{Amax}}∫_{δ}_{_{Dmin}}^{δ}^{_{Dmax}} [symbol] ∫_{δ}_{_{Pmin}}^{δ}^{_{Pmax}}∫_{δVmin}^{(t}^{₁}^{-t}^{ₐ}^{-t}^{ₘ}^{)/K}^{_{V}}⁺¹ƒ_{V}(δ_{V})dδ_{V}ƒ_{P}(δ_{P})dδ_{P} [symbol] ( [symbol] )d [symbol] ƒ_{D}(δ_{D}dδ_{D}ƒ_{A}(δ_{A})dδ_{A} (28).

In step G, the reliability degrees are calculated and determined when the running temperature of the motor winding is lower than the given temperature under different environment temperatures.

A calculation formula of the running temperature of the motor winding is obtained by accumulating the motor running basic temperature under a certain environment temperature and values of decrease or increase, caused by the various factors, of the temperature rise, according to the method of step F, for different environment temperatures, progressive increasing is performed at a 0.2° C. winding running temperature step size for iterative calculation, and the reliability degrees are obtained when the running temperature of the motor winding is lower than or equal to given different temperatures; as shown in FIG. 1, the reliability degrees are calculated when the running temperature of the motor winding is lower than or equal to the given different temperatures, equal reliability degree points are connected with a curve, the reliability degree of the curve 2 is P=0, the reliability degree of the curve 3 is P=100%, and the reliability degree of the curve 4 is P=95%.

Relationship curves of the reliability degrees of the motor temperature rise and the given motor winding temperature under different environment temperatures are made, as shown in FIG. 4, and curves with serial numbers being 1-8 represent different environment temperatures.

In step H, a calculation and determination method of the reliability degree of the running temperature rise of the motor winding is as follows:

Corresponding to the allowable highest temperature of the motor winding for the motor insulation grade, a horizontal line is drawn on FIG. 1, intersection points of the horizontal line and curves of different equal reliability degrees are reliability degrees of the motor temperature rise under corresponding environment temperatures, and change of the temperature rise reliability degrees along with the environment temperatures is made, as shown in FIG. 5, and may be used for motor design, selection and running.

The present invention has the beneficial effects that the prediction method for the reliability degree of the running temperature rise of the large and medium-sized motor provided by the present invention includes determining the main influence factors of the temperature rise of the motor winding, calculating the heating quantity and the temperature rise of the motor under influences of certain factors, determining the random numerical characteristics of the main influence factors of the temperature rise of the motor winding, calculating and determining possible minimum values and possible maximum values of running temperatures of the motor winding under different environment temperatures, calculating and determining the reliability degrees when the running temperature of the motor winding is lower than the given temperature under different environment temperatures, and calculating and determining the reliability degree of the running temperature rise of the motor winding. The present invention can accurately predict a probability when the running temperature of the motor is lower than the allowable highest temperature under influences of the plurality of uncertain factors, the prediction method is more scientific, the prediction results are more reasonable, a scientific basis is provided for design, selection and application of the motor and the ventilation cooling system of the motor, a safety and reliability degree of the motor running is improved, and important theory academic value and engineering application significance are achieved.

### BRIEF DESCRIPTION OF THE DRAWINGS

FIG. 1 is a schematic view of a running temperature of a motor stator winding under different environment temperatures in the present invention.

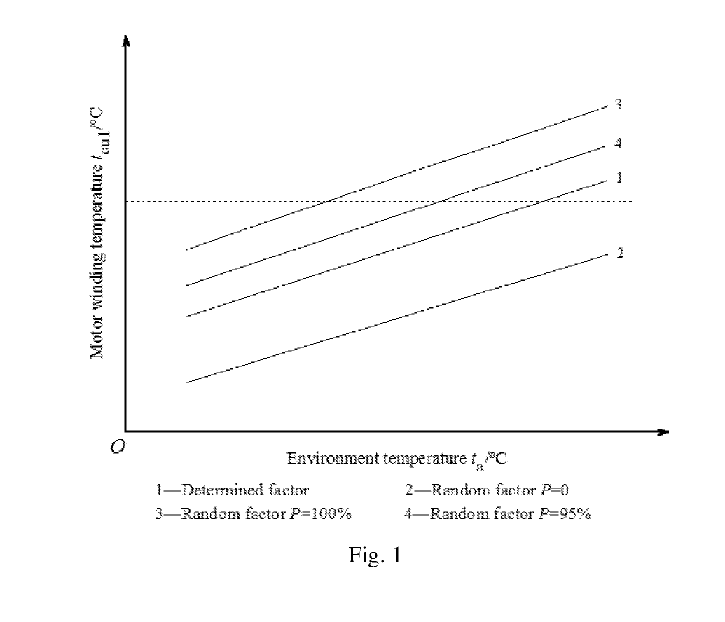

FIG. 2 is a schematic view of a probability density function ƒ_{P}(δ_{P}) and composite calculation of a reliability degree of motor power in the present invention.

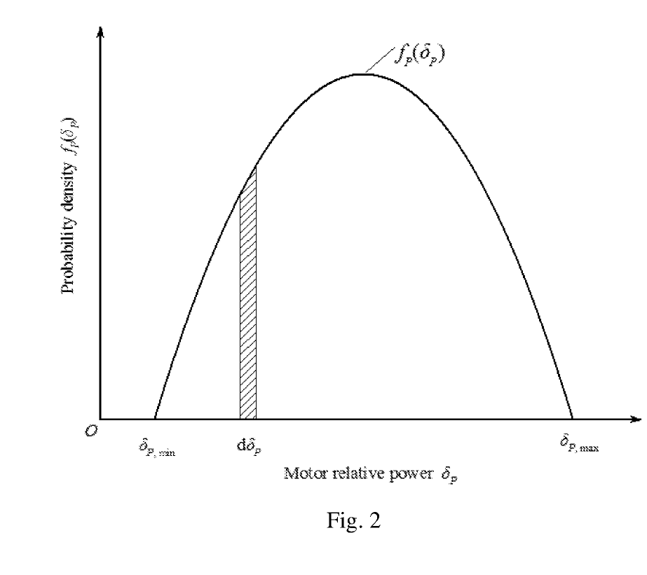

FIG. 3 is a schematic view of a probability density function ƒ_{V}(δ_{V}) and composite calculation of a reliability degree of power network voltage in the present invention.

FIG. 4 is a schematic view of changes of a motor temperature rise reliability degree along with the given motor winding temperature in the present invention.

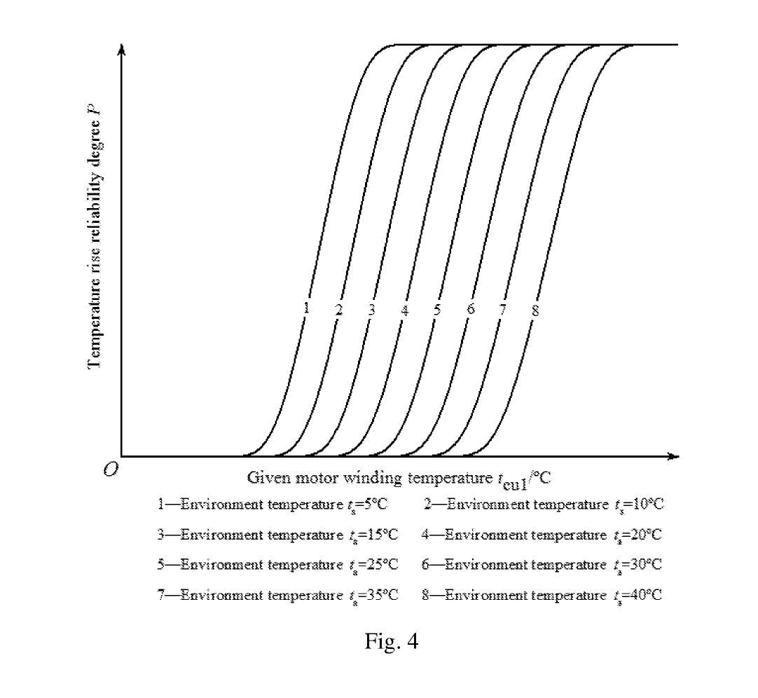

FIG. 5 is a schematic view of changes of the motor temperature rise reliability degree along with the environment temperature in the present invention.

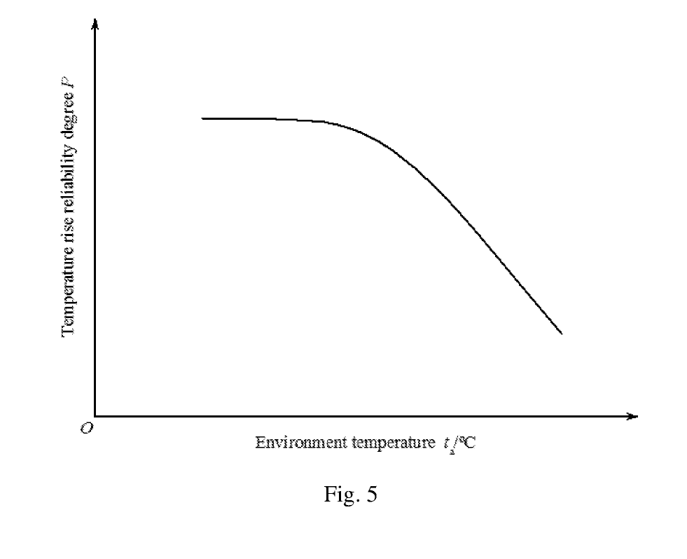

FIG. 6 is a running temperature chart of the motor stator winding corresponding to different reliability under different environment temperatures when one draught fan or two draught fans run according to an embodiment of the present invention.

FIG. 7 is a change diagram of the motor temperature rise reliability degree along with the given motor winding temperature under different environment temperatures when two draught fans run according to the embodiment of the present invention.

FIG. 8 is a change diagram of the temperature rise reliability degree along with the environment temperature when one draught fan or two draught fans run and the allowable highest temperature of a motor winding is 100° C. according to the embodiment of the present invention.

### DETAILED DESCRIPTION OF THE INVENTION

The present invention is further illustrated below in conjunction with the accompanying drawings and embodiments.

A motor matched with a main water pump of a certain pump station for use is a synchronous motor, a rated voltage is 6000 V, a rated current is 180 A, a phase number is 3, an insulation grade is Grade F, an iron core mass is 3.693 t, an iron core height is 370 mm, a ventilation trough number is 6, a ventilation trough height is 10 mm, an iron core inner diameter is 2290 mm, an iron core outer diameter is 2600 mm, a slot height of a ventilation slot is 10 mm, a slot width is 18 mm, an iron core length is 155 mm, a ventilation slot number is 216, phase resistance is 0.2416 Ω when a stator is at 75° C., an excitation current under a rated load is 177 A, and winding resistance is 0.6398 Ω.

In step A, the main influence factors of the temperature rise of the motor winding are determined.

When an environment temperature is 20° C., and a ventilation flow rate is 6.32 m³/s, based on calculation, temperature rise error ranges caused by various factors having influences on the temperature rise of the motor winding are as shown in Table 1:

TABLE 1
The motor temperature rise error ranges caused in case that the various
influence factors change randomly when the ventilation flow rate is
6.32 m³/s

| Influence factor of temperature rise of motor | Temperature rise |
|---|---|
| winding | error range (° C.) |
| Running power | [−10.509, 12.449] |
| Power network voltage fluctuation | [−4.414, 4.414] |
| Ventilation flow rate | [−2.959, 2.624] |
| Ventilation slot heat exchange area | [−1.987, 1.895] |
| Winding insulation thickness | [−1.440, 1.440] |
| Stator winding resistance | [−0.344, 0.344] |
| Power network frequency fluctuation | [−0.0206, 0.0196] |
| Iron core length | [0, 0.076] |

Through comparison, it may be known that, the main factors influencing the temperature rise of the motor include five factors of the motor running power, the power network voltage fluctuation, the winding insulation layer thickness, the ventilation slot heat exchange area and the ventilation flow rate.

In step B, the heating quantity of the motor is calculated:

A motor iron core loss, a stator winding copper loss, an excitation winding copperloss and a ventilation friction resistance loss may be calculated with formulae (1) to (4). For example, when the environment temperature is 20° C., the iron core loss is 7.001 kW, a stator winding copper loss is 34.756 kW, an excitation winding copper loss is 20.044 kW, and the ventilation friction resistance loss is relevant to the ventilation flow rate and resistance.

In step C, temperature rises of the motor winding under different environment temperatures are calculated:

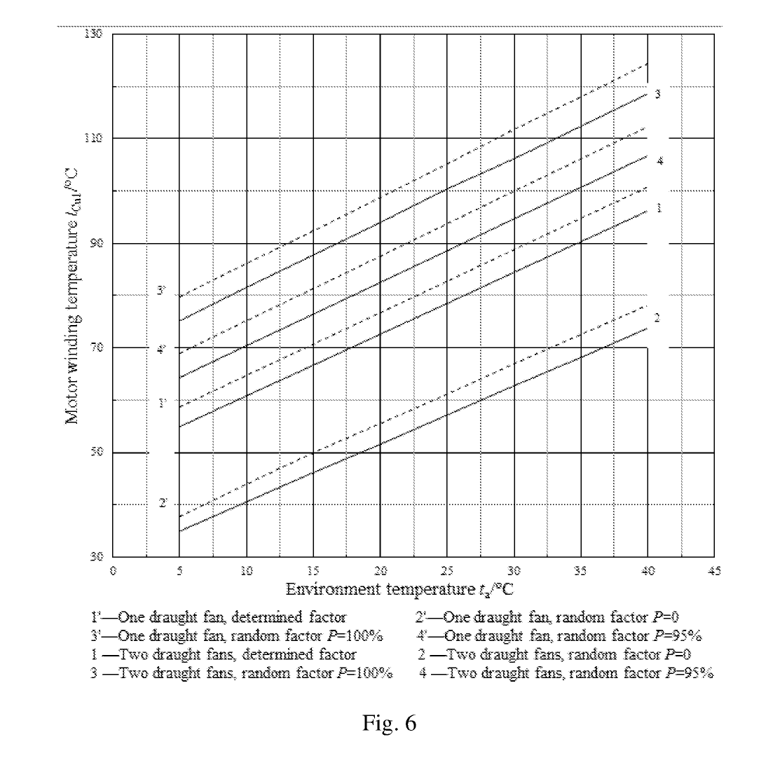

It is known that an area of the ventilation slots of a stator is 11.249 m²; a total area of the ventilation openings of a stator iron core is 0.233 m²; a total area of inner and outer cylindrical surfaces of the stator iron core is 5.603 m²; a total heat dissipating area of the stator iron core is 16.386 m²; a contact area of the stator winding and the iron core is 11.872 m², a ventilation duct resistance coefficient of the motor may be calculated with formulae (5) to (8), and the temperature rise of the winding may be calculated and determined with formulae (9) to (16). For example, when the environment temperature is 20° C., the flow rate provided by two draught fans selected for use is 6.32 m³/s, and the temperature rise of the winding is 52.644° C. Running temperature rises of the motor stator winding under other environment temperatures and under effects of determined influence factors are obtained by calculation in the similar way, and by adding the environment temperature, the running temperatures of the motor are obtained, as shown by curves 1 and 1′ in FIG. 6.

In step D, the random numerical characteristics of the influence factors of the temperature rise of the motor winding are determined:

Factors such as design, installation and running may cause the running power of a pump station unit to change. Prototype and model conversion error, a water pump characteristic error, a pipeline characteristic error, a vortex of entering flow and a pump station head change all may generate a random error on the running power of the motor. Through analysis, a random change range of relative running power δ_{P} of the motor is [0.9025, 1.1155];

As stipulated by a national power supply standard, an allowed range of the power network voltage fluctuation is ±5%, and therefore a range of a random change rate δ_{V} of a power network voltage is [0.95, 1.05];

As stipulated by a manufacturing standard, an error of insulation of the motor winding does not exceed ±7%, and therefore a random change range of a winding insulation relative thickness δ_{D} is [0.93, 1.07];

As stipulated by the standard, a machining error of a size of the motor stator ventilation slot does not exceed 10%, and therefore a random change rate of a size of a cross section of the ventilation slot is [0.9, 1.1], and correspondingly, a random change rate change of a ventilation slot relative heat exchange area δ_{A} is [0.81, 1.21];

It is hard to avoid errors during calculation of the resistance coefficient of the ventilation duct of the motor, and draught fan performance may also bring an error for determination of the ventilation flow rate. After analysis, when an original ventilation flow rate is 6.32 m³/s, a random change range of a relative ventilation flow rate [symbol] is [0.9, 1.14], and when the original ventilation flow rate is 5.339 m³/s, a range of a random change rate [symbol] of the ventilation flow rate is [0.932, 1.075]. Temperature influence coefficients of the various influence factors under different random change rates may be calculated with formulae (17) to (21), as shown in Table 2 and Table 3.

TABLE 2
Temperature influence coefficients of the various influence factors
when the ventilation flow rate is 6.32 m³/s

| tₐ | K_{P} | K_{V} | K_{D} | Δt_{A} | Δt_{Q} |
|---|---|---|---|---|---|
| 5 | 102.46 | 84.37 | 20.16 | −4.29δ_{A}_{²} + 26.73δ_{A} − | −17.40 [symbol] + 72.49 [symbol] |
| | | | | 22.44 | 114.77 [symbol] + 59.69 |
| 10 | 104.28 | 85.71 | 20.30 | −4.39δ_{A}_{²} + 27.36δ_{A} − | −17.93 [symbol] + 74.68 [symbol] |
| | | | | 22.97 | 118.21 [symbol] + 61.46 |
| 15 | 106.00 | 86.97 | 20.44 | −4.49δ_{A}_{²} + 27.98δ_{A} − | −18.40 [symbol] + 76.62 [symbol] |
| | | | | 23.49 | 121.28 [symbol] + 63.05 |
| 20 | 107.78 | 88.27 | 20.57 | −4.59δ_{A}_{²} + 28.60δ_{A} − | −18.91 [symbol] + 78.75 [symbol] |
| | | | | 24.01 | 124.62 [symbol] + 64.78 |
| 25 | 109.54 | 89.57 | 20.70 | −4.69δ_{A}_{²} + 29.20δ_{A} − | −19.42 [symbol] + 80.88 [symbol] |
| | | | | 24.51 | 127.96 [symbol] + 66.51 |
| 30 | 111.38 | 90.92 | 20.82 | −4.78δ_{A}_{²} + 29.80δ_{A} − | −19.99 [symbol] + 83.22 [symbol] |
| | | | | 25.02 | 131.62 [symbol] + 68.39 |
| 35 | 113.08 | 92.15 | 20.95 | −4.88δ_{A}_{²} + 30.38δ_{A} − | −20.47 [symbol] + 85.24 [symbol] |
| | | | | 25.50 | 134.80 [symbol] + 70.03 |
| 40 | 114.83 | 93.42 | 21.07 | −4.97δ_{A}_{²} + 30.99δ_{A} − | −20.98 [symbol] + 87.34 [symbol] |
| | | | | 26.02 | 138.11 [symbol] + 71.75 |

TABLE 3
Temperature influence coefficients of the various influence factors
when the ventilation flow rate is 5.339 m³/s

| tₐ | K_{P} | K_{V} | K_{D} | Δt_{A} | Δt_{Q} |
|---|---|---|---|---|---|
| 5 | 109.50 | 89.40 | 19.98 | −5.98δ_{A}_{²} + 32.14δ_{A} − | −20.49 [symbol] + 84.32 [symbol] |
| | | | | 26.16 | 132.41 [symbol] + 68.58 |
| 10 | 111.52 | 90.88 | 20.12 | −6.12δ_{A}_{²} + 32.89δ_{A} − | −20.49 [symbol] + 84.32 [symbol] |
| | | | | 26.78 | 132.41 [symbol] + 68.58 |
| 15 | 113.43 | 92.27 | 20.25 | −6.25δ_{A}_{²} + 33.63δ_{A} − | −21.68 [symbol] + 89.19 [symbol] |
| | | | | 27.38 | 139.99 [symbol] + 72.48 |
| 20 | 115.41 | 93.71 | 20.38 | −6.39δ_{A}_{²} + 34.38δ_{A} − | −22.29 [symbol] + 91.69 [symbol] |
| | | | | 27.99 | 143.88 [symbol] + 74.48 |
| 25 | 117.36 | 95.13 | 20.51 | −6.53δ_{A}_{²} + 35.10δ_{A} − | −22.90 [symbol] + 94.20 [symbol] |
| | | | | 28.57 | 147.78 [symbol] + 76.48 |
| 30 | 119.40 | 96.63 | 20.63 | −6.66δ_{A}_{²} + 35.83δ_{A} − | −23.58 [symbol] + 96.97 [symbol] |
| | | | | 29.17 | 152.07 [symbol] + 78.68 |
| 35 | 121.28 | 98.00 | 20.75 | −6.79δ_{A}_{²} + 36.52δ_{A} − | −24.16 [symbol] + 99.35 [symbol] |
| | | | | 29.73 | 155.77 [symbol] + 80.58 |
| 40 | 123.23 | 99.40 | 20.87 | −6.93δ_{A}_{²} + 37.26δ_{A} − | −24.77 [symbol] + 101.83 [symbol] |
| | | | | 30.33 | 159.63 [symbol] + 82.6 |

With the winding insulation thickness of the influence factors of the temperature rise of the motor winding when two draught fans run as an example, a corresponding probability density function ƒ_{D}(δ_{D}) is calculated, a change rate range of δ_{D} is [0.93, 1.07] and is substituted into formulae (23) to (25), and calculation is as follows:

0.93²×a+0.93×b+c=0

1.07²×a+1.07×b+c=0

∫ₓ_{ₘᵢₙ}^{x}^{ₘₐₓ}(ax²+bx+c)dx=1

Simultaneous solving is performed, and the probability density function of the influence factor of the motor winding insulation thickness is obtained:

ƒ(x)=−2186.5889x²+4373.1778x−2175.8746

Corresponding probability density functions are respectively solved for the other several types of influence factors of the temperature rise of the motor winding by adopting the method, as shown in Table 4 and Table 5.

TABLE 4
The probability density functions of the various influence factors
when the ventilation flow rate is 6.32 m³/s

| Motor winding influence | |
|---|---|
| factor | Probability density function |
| Motor power δ_{P} | ƒ (x) = −620.8868x² + 1252.9496x − |
| | 625.0708 |
| Power network voltage δ_{V} | ƒ (x) = −6000x² + 12000x − 5985 |
| Ventilation flow rate [symbol] | ƒ (x) = −434.0278x² + 885.4167x − |
| | 445.3125 |
| Winding insulation | ƒ (x) = −2186.5889x² + 4373.1778x − |
| thickness δ_{D} | 2175.874636 |
| Ventilation slot heat | ƒ (x) = −93.75x² + 189.375x − 91.8844 |
| exchange area δ_{A} | |

TABLE 5
The probability density functions of the various influence factors
when the ventilation flow rate is 5.339 m³/s

| Motor winding influence | |
|---|---|
| factor | Probability density function |
| Motor power δ_{P} | ƒ (x) = −620.8868x² + 1252.9496x − |
| | 625.0708 |
| Power network voltage δ_{V} | ƒ (x) = −6000x² + 12000x − 5985 |
| Ventilation flow rate [symbol] | ƒ (x) = −2051.8383x² + 4118.0395x − |
| | 2055.7368 |
| Winding insulation | ƒ (x) = −2186.5889x² + 4373.1778x − |
| thickness δ_{D} | 2175.8746 |
| Ventilation slot heat | ƒ (x) = −93.75x² + 4189.375x − 91.8844 |
| exchange area δ_{A} | |

E. Possible minimum and maximum values of the running temperatures of the motor under different environment temperatures are calculated and determined:

A motor running basic temperature under a certain environment temperature of an embodiment and extreme values of decrease or increase of the temperature rise caused by the various factors are accumulated to obtain the possible minimum and maximum values of the running temperature of the motor winding under the environment temperature, and the calculation results are as shown by curves 2 and 2′ and curves 3 and 3′ in FIG. 6.

F. A calculation method of the reliability degree when the running temperature of the motor winding is lower than a certain given temperature:

With the environment temperature being 20° C. and the given motor winding temperature being 80° C. as an example, the reliability degree P₅ when the running temperature of the motor winding is lower than 80° C. is calculated, δ_{P}=[0.9025, 1.1155], δ_{V}=[0.95, 1.05], [symbol] , 1.14], δ_{D}=[0.93 1.07] and δ_{A}=[0.81, 1.21] and the probability density functions ƒ_{P}(δ_{P}),ƒ_{V}9δ_{V}), [symbol] [symbol] ,ƒ_{D}9δ_{D}) and ƒ_{A}9δ_{A}) are known, and at the moment, the given motor winding temperature is:

$$\begin{matrix}{t}_{5} = 80 ° C . = {t}_{a} + {t}_{m} + Δ {t}_{P} + Δ {t}_{V} + Δ {t}_{Q} + Δ {t}_{D} + Δ {t}_{A} \\ = {t}_{a} + {t}_{m} + 107.7816 ( {δ}_{P} - 1 ) + 88.2742 ( {δ}_{V} - 1 ) + \\ 20.5710 ( {δ}_{D} - 1 ) - 4.5905 {δ}_{A}^{2} + 28.5996 {δ}_{A} - 24.0091 - \\ 18.9090 {δ}_{Q}^{3} + 78.7495 {δ}_{Q}^{2} - 124.6214 {δ}_{Q} + 64.7805\end{matrix}$$

Programming calculation is performed by utilizing MATLAB software, in the random value range of each influence factor, a reasonable iteration step size is set, micro widths being dδ_{P}, dδ_{V}, d [symbol] , dδ_{D} and dδ_{A} are sequentially taken from small, a constraint condition that the running temperature of the motor winding t≤t₅ is met, that is, tₐ+tₘ+Δt_{P}+Δt_{V}+ [symbol] +Δt_{D}≤t₅−Δt_{A}=t₄, tₐ+tₘ+Δt_{P}+Δt_{V}+ [symbol] ≤t₄−Δt_{D}=t₃, tₐ+tₘ+Δt_{P}+Δt_{V}≤t₃− [symbol] =t₂, tₐ+tₘ+Δt_{V}≤t₂−Δt_{P}=t₁ and δ_{V}≤(t₁−tₐ−tₘ)/K_{V}+1 are sequentially met, a probability P₁=∫_{δ}_{_{v min}}^{(t}^{₁}^{-t}^{ₐ}^{-t}^{ₘ}^{)/K}^{_{V}}⁺¹ ƒ_{V}(δ_{V})dδ_{V} is obtained, and is substituted into a P₂=∫_{δ}_{_{Pmin}}^{δ}^{_{Pmax}}P₁·ƒ_{P}(δₚ)dδ_{P} calculation formula, then P₂ is substituted into P₃= [symbol] P₂· [symbol] ( [symbol] ) d [symbol] , the rest can be done in the same way, that is, P₅ may be obtained due to calculation with a formula (28).

G. Calculation and determination for reliability degrees when the running temperature of the motor winding is lower than a given temperature under different environment temperatures:

For the environment temperature from 5° C. to 40° C., valuing is performed every other 5° C., the reliability degrees under eight different environment temperatures when a step size of the running temperature of the winding is given, and iteration is performed at 0.2° C. progressive increase, linear interpolation is performed on data, given motor winding temperatures are taken when the reliability degrees P are respectively 0, 30%, 50%, 80%, 95%, 98%, 100% and the like, and corresponding equal reliability degree lines are made. For conciseness and clearness, equal reliability degree lines when the reliability degrees P are respectively 0, 95% and 100% are given in FIG. 6.

Curves 1, 2, 3 and 4 respectively represent equal reliability degree lines when two draught fans run, the influence factors of the stator winding temperature rise are determined with a random factor P=0, 100% and 95%, and the curves are shown with solid lines; curves 1′, 2′, 3′ and 4′ respectively represent equal reliability degree lines when one draught fan runs, the influence factors of the stator winding temperature rise are determined with a random factors P=0, 100% and 95%, and the curves are shown with imaginary lines. Along with rising of the environment temperature, the curves are all in a tendency of monotone increasing. Under the same environment temperature, for the same given motor winding temperature, the reliability degree of the motor temperature rise when one draught fan runs is lower than the reliability degree of the motor temperature rise when two draught fans run; or under the same allowable highest motor winding temperature, the environment temperature at which two draught fans can run is higher than the environment temperature at which one draught fan can run.

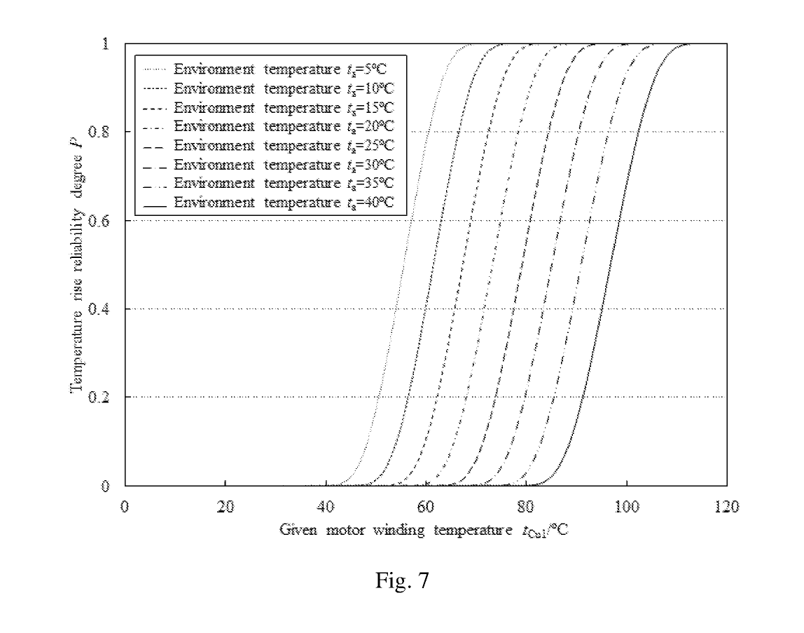

FIG. 7 is a change diagram of the temperature rise reliability degree along with the given motor winding temperature, each curve represents one environment temperature, the environment temperature is sequentially increased from left to right, it can be known from the FIG. 7 that, under the various environment temperatures, corresponding to one given motor winding temperature of an abscissa-namely the allowable highest temperature, the higher the environment temperature is, the more rightwards the reliability degree line moves, and the lower the temperature rise reliability degree is.

H. The reliability degree of the running temperature rise of the motor winding is calculated and determined:

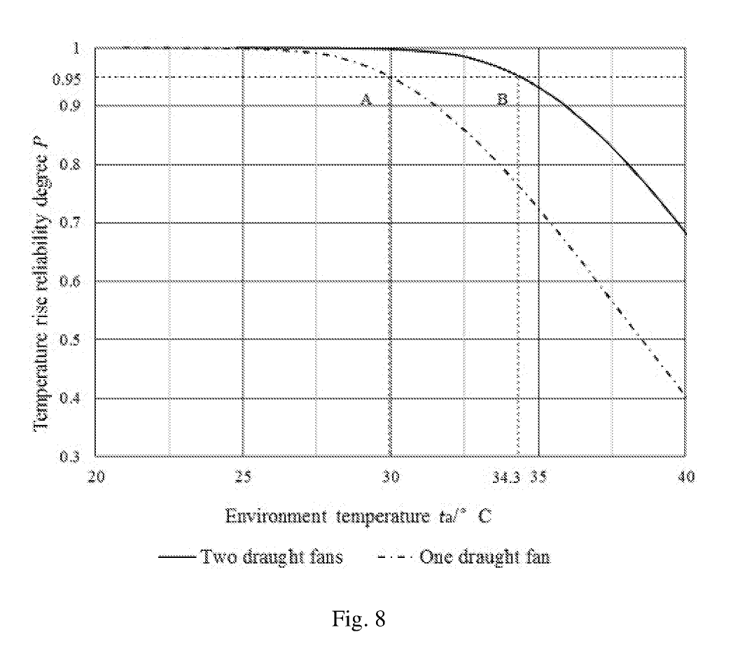

In FIG. 6, more equal reliability degree lines of changes of the motor winding temperature along with the environment temperature are calculated and determined, the allowable highest temperature corresponding to the motor insulation grade is 100° C., a horizontal line with a temperature being 100° C. is drawn on FIG. 6, the horizontal line is intersected with different equal reliability degree curves of one draught fan and two draught fans, intersection points are the reliability degrees of the motor temperature rise under corresponding environment temperatures, and a change diagram of the reliability degree of the temperature rise of one draught fan and two draught fans along with the environment temperature is made, as shown in FIG. 8.

It is known from FIG. 8 that, along with rising of the environment temperature, the reliability degree of the motor temperature rise is lowered, and if it is stipulated that the reliability degree of the temperature rise is required not to be lower than 95%, a horizontal line of a 95% reliability degree is intersected with one draught fan and two draught fans at points A and B respectively. When the environment temperature is 30° C. or below, one draught fan may be selected to run, so that ventilation cost is saved; when the environment temperature is 30° C. to 34.3° C., the two draught fans should run, which is able to guarantee that the reliability degree of the motor temperature rise is larger than or equal to 95%; and when the environment temperature is larger than 34.3° C., even though two draught fans run, the reliability degree of the motor temperature rise is still lower than 95%, and especially when the environment temperature reaches 40° C., the reliability degree of the motor temperature rise is only 68.5%, but the situation hardly occurs.

Calculation in the embodiment explains that the calculation method, provided by the present invention, for the reliability degree of the motor temperature rise under different environment temperatures while simultaneous influences of the plurality of uncertain factors are considered is able to accurately predict the reliability degree of the temperature rise of the motor working under an actual complicated environment, the prediction method is more scientific, the prediction results are more reasonable, a scientific basis is provided for improved design, reasonable selection and running management of the motor and the ventilation system thereof, and guarantee of running safety of the motor, and important theory academic value and engineering application significance are achieved.

What is claimed is:

1. A prediction method for reliability degree of running temperature rise of a large and medium-sized motor, comprising following operation steps:
A. determining main influence factors of a temperature rise of a motor winding;
B. calculating a heating quantity of the motor;
C. calculating temperature rises of the motor winding under different environment temperatures;
D. determining random numerical characteristics of the influence factors of the temperature rise of the motor winding;
E. calculating and determining possible minimum and maximum values of running temperatures of the motor winding under different environment temperatures;
F. a calculation method for the reliability degree when the running temperature of the motor winding is less than a certain given temperature;
G. calculating and determining reliability degrees when the running temperature of the motor winding is less than the given temperature under different environment temperatures; and
H. calculating and determining the reliability degree of the running temperature rise of the motor winding,
wherein in step A, the main influence factors of the temperature rise of the motor winding are determined as follows:
heat source of the motor temperature rise comprise: a winding copper loss, an iron core loss and an excitation loss, and when motor cooling is carried out by adopting a manner of forced ventilation by a draught fan, heat generated due to ventilation friction also needs to be considered; according to calculation and comparison, the main factors influencing the motor temperature rise comprise motor running power, power network voltage, the winding insulation layer thickness, the ventilation slot heat exchange area and the ventilation flow rate;
in step B, the heating quantity of the motor is calculated as follows:
the heating quantity of the motor mainly comes from the iron core loss, the winding copper loss and the excitation loss, and heat generated by a mechanical loss of a thrust bearing and two guide bearings of the motor is taken away by cooling water in a cooler, and is not reckoned into a ventilation cooling load, wherein a calculation formula of the iron core loss is:
$${P}_{Fe} = {K}_{a} {p}_{0} {B}^{2} {{M}_{Fe} ( \frac{f}{50} )}^{1.3} \qquad ( 1 )$$
in the formula: Kₐ—experience coefficient; ƒ—alternating frequency; p₀—loss of per unit mass iron core when ƒ is 50 Hz; B—magnetic flux density; and M_{Fe}—mass of the iron core;
a calculation formula of a stator winding copper loss is:
P_{cu1}=mm_{c}I₁²r₁ (2)
in the formula: m—motor phase number; m_{c}—insulation temperature rise coefficient, 1.4 is selected for Grade B insulation, and 1.48 is selected for Grade F insulation; I₁—phase current; and r₁—phase resistance;
a synchronous motor excitation winding copper loss may be calculated with a following formula:
P_{Cu2}=i₂²r₂ (3)
in the formula: I₂—excitation current; and r₂—excitation winding resistance;
for the motor adopting the draught fan for ventilation, a ventilation friction resistance loss needs to be considered, and ventilation friction resistance loss power is:
P_{V}= [symbol] p (4)
in the formula: [symbol] —ventilation flow rate; and p—full pressure loss generated in a process that air passes through the motor during motor ventilation;
in step C, the temperature rises of the motor winding under different environment temperatures are calculated as follows:
firstly, resistance coefficients of various portions of the ventilation duct and the ventilation loop of the motor are calculated, and the flow rate of the draught fan at an actual work condition point is determined according to the flow rate-full pressure performance curve of the draught fan matched for use and the required pressure curve of the ventilation system; then according to air duct arrangement, an actual air velocity in each segment of the ventilation duct is determined; and a heat exchange coefficient of a heat exchange surface is obtained from the air velocity, and then is substituted into a temperature rise calculation formula, and the motor temperature rise under a certain environment temperature is obtained;
a friction pressure loss is:
$$Δ {p}_{f} = {\sum }_{i = 1}^{m} {λ}_{i} \frac{{l}_{i}}{{d}_{i}} \frac{ρ}{2} {v}_{i}^{2} = {\sum }_{i = 1}^{m} {λ}_{i} \frac{{l}_{i}}{{d}_{i}} \frac{ρ}{2 {A}_{i}^{2}} {Q}^{2} \qquad ( 5 )$$
in the formula, i—serial number of a friction loss of the ventilation loop; m—sum of the friction losses of the ventilation loop; λ—friction resistance coefficient; l—flow channel length; d—flow channel equivalent diameter, and when a flow channel is a rectangular pipeline,
$$d = \frac{2 hb}{h + b} ;$$
h—height of a section of the rectangular pipeline; b—breadth of the section of the rectangular pipeline; ρ—density of air; v—air velocity; A—area of a cross section of the flow channel; and [symbol] —flow rate of ventilation;
a local pressure loss is:
$$Δ {p}_{j} = {\sum }_{j = 1}^{n} {ζ}_{j} \frac{ρ}{2} {v}_{j}^{2} = {\sum }_{j = 1}^{n} \frac{{ζ}_{j} ρ}{2 {A}_{j}^{2}} {Q}^{2} \qquad ( 6 )$$
in the formula: j—serial number of a local resistance; n-local resistance sum; and ζ—local loss coefficient;
an equivalent air resistance of an air course formed by n air resistances connected in series is:
$$Z = {\sum }_{i = 1}^{n} {Z}_{i} \qquad ( 7 )$$
an equivalent air resistance of an air course formed by n air resistances connected in parallel is:
$$Z = \frac{1}{{( {\sum }_{i = 1}^{n} \frac{1}{\sqrt{{Z}_{i}}} )}^{2}} \qquad ( 8 )$$
a total area of a stator ventilation slot is:
S₁=2z₁l₁(hₙ+bₙ) (9)
in the formula, hₙ—slot height, bₙ—slot breadth; l₁—stator iron core length; and z₁—stator ventilation slot number;
a total area of ventilation openings of the stator iron core is:
S₂=z₁bₙhₙ (10)
a total area of inner and outer cylindrical surfaces of the stator iron core is:
S₃=π(D₁+D₂)h (11)
in the formula: D₁—outer circle diameter of the stator iron core; D₂—inner circle diameter of the stator iron core; and h—height of the stator iron core;
a total heat dissipating area of the station iron core is:
S_{Fe}=S₁+S₃−2S₂ (12)
a contact area of the stator winding and the iron core is:
S₄=n₁L₁h₁ (13)
in the formula: n₁—winding branch number; L₁—perimeter of a contact surface of the winding and the iron core; and h₁—length of the contact surface of the winding and the iron core
an average wind velocity in an air duct is:
v= [symbol] /s (14)
in the formula: s—sectional area of the air duct;
a radial ventilation slot surface heat exchange coefficient:
$$α = \frac{1 + 0.24 v}{0.045} \qquad ( 15 )$$
the winding temperature rise is:
$$\begin{matrix}{t}_{m} = Δ {t}_{1} + Δ {t}_{Fe 1} + Δ {t}_{Fea} + Δ {t}_{a} \\ = \frac{{ϕ}_{CF} {P}_{Cu 1} δ}{{λ}_{1} {S}_{4}} + \frac{{qL}_{Fe 1}^{2}}{12 {k}_{Fe}} + \frac{{P}_{1}}{α {S}_{Fe}} + \frac{\sum P}{CQ} \\ = \frac{{ϕ}_{CF} {P}_{Cu 1} δ}{{λ}_{1} {S}_{4}} + \frac{( {P}_{Fe} + {ϕ}_{CF} {P}_{Cu 1} ) {L}_{Fe 1}^{2}}{12 {k}_{Fe} {S}_{1}} + \\ \frac{{P}_{Fe} + {ϕ}_{CF} ( {P}_{Cu 1} + {P}_{Cu 2} )}{α {S}_{Fe}} + \frac{\sum P}{{C}_{a} Q}\end{matrix} \qquad ( 16 )$$
in the formula: Δt₁—winding insulation layer temperature drop; Δt_{Fe1}—iron core interior average temperature difference; Δt_{Fea}—temperature difference between a surface of an iron core segment and air; Δtₐ—air temperature rise; φ_{CF}—loss component transmitted to the iron core from copper; q—unit volume heat flowing in axis direction of the iron core; L_{Fe1}—iron core length; P₁—loss dissipated through the iron core; λ₁—winding insulation heat conduction coefficient, the insulation heat conduction coefficient is relevant to temperature, and insulation heat conduction coefficients under different environment temperatures are obtained through an iterative operation approximation method; k_{Fe}—coefficient; α—surface heat exchange coefficient of ventilation slot; ΣP—total heating quantity of the motor; Cₐ—air volume specific heat capacity; and [symbol] —ventilation flow rate;
a resistance coefficient of the ventilation duct of the motor is calculated, and an actual ventilation flow rate and a ventilation friction resistance loss of the draught fan are determined in conjunction with the draught fan performance curves; and the temperature rises, under different environment temperatures, of the motor winding under effects of the determined influence factors are calculated, and by adding an environment temperature, motor running temperatures are obtained and are drawn on a figure.

2. The prediction method for reliability degree of running temperature rise of a large and medium-sized motor according to claim 1, wherein in step D, the random numerical characteristics of the influence factors of the temperature rise of the motor winding are determined by taking a ratio of any factor value in random change to an original determined value, namely, a relative value δ of the factor, a random value range of δ is [δₘᵢₙ, δₘₐₓ], random influence factors comprise motor relative power δ_{P}, the power network relative voltage δ_{V}, the winding insulation layer relative thickness δ_{D}, the ventilation slot relative heat exchange area δ_{A} and a relative ventilation flow rate [symbol] , random vibration ranges of the above factors are respectively [δ_{Pmin}, δ_{Pmax}], [δ_{Vmin}, δ_{Vmax}], [δ_{Dmin}, δ_{Dmax}], [δ_{Amin}, δ_{Amax}] and [ [symbol] , [symbol] ], and temperature rise change calculation formulae of the influence factors are obtained and are respectively:
Δt_{P}=g₁(δ_{P}) (17)
Δt_{V}=g₂(δ_{V}) (18)
Δt_{D}=g₃(δ_{D}) (19)
Δt_{A}=g₄(δ_{A}) (20) [symbol]
=g₅( [symbol] ) (21)
a probability density function determination method of random change of relative values of the influence factors is as follows:
according to the random change range [xₘᵢₙ, xₘₐₓ] of the influence factors of the motor winding temperature rise, a probability density function ƒ(x) is determined, a probability density distribution type is parabolic distribution, an opening faces downwards, and a calculation formula is:
ƒ(x)=ax²+bx+c(a≠0) (22)
according to non-negativity of the probability density function, an upper limit and a lower limit of the random change range of the influence factor are substituted in, a probability density value is 0, and probability density values of other values in the domain of definition are all larger than 0; and according to normativity of the probability density function, an area surrounded by the probability density function curve and x axis is 1, and specific formulae are as follows:
axₘᵢₙ² +bxₘᵢₙ+c=0 (23)
axₘₐₓ²+bxₘₐₓ+c=0 (24)
∫ₓ_{ₘᵢₙ}^{x}^{ₘₐₓ}ƒ(x)dx=1 (25)
the coefficients a, b and c of the probability density function are solved by combining the three equations (23), (24) and (25), and corresponding probability density functions are respectively solved for the several types of influence factors of the temperature rise of the motor winding by adopting the method.

3. The prediction method for reliability degree of running temperature rise of a large and medium-sized motor according to claim 2, wherein in step E, the possible minimum and maximum values of the running temperatures of the motor winding under different environment temperatures are calculated and determined by accumulating a motor running basic temperature under a certain environment temperature and extreme values of decrease or increase, caused by various random factors, of the temperature rise to obtain possible minimum and maximum values of the running temperature of the motor winding under the environment temperature, and calculation formulae are as follows:
t_{Cu1min}=tₐ+tₘ+Δt_{Pmin}+Δt_{Vmin}+Δt_{Dmin}+Δt_{Amin}+ [symbol] ₘᵢₙ (26)
t_{Cu1max}=tₐ+tₘ+Δt_{Pmax}+Δt_{Vmax}+Δt_{Dmax}+ΔAmax+ [symbol] ₘₐₓ (27)
in the formula: tₐ is an environment temperature, and under different environment temperatures, the possible lowest and highest running temperatures of the motor winding are respectively shown by curves in a figure.

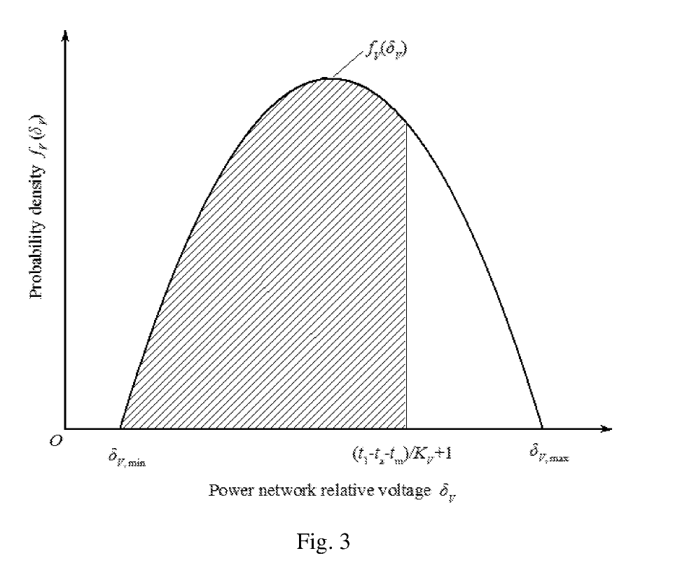

4. The prediction method for reliability degree of running temperature rise of a large and medium-sized motor according to claim 2, wherein in step F, the calculation method for the reliability degree when the running temperature of the motor winding is lower than a certain given temperature is carried out in a manner that the random value ranges and probability density functions of the influence factors of the motor power δ_{P}, the power network voltage δ_{V}, the ventilation flow rate [symbol] the winding insulation thickness δ_{D} and the ventilation slot heat exchange area δ_{A} are respectively known as ƒ_{P}(δ_{P}),ƒ_{V}(δ_{V}), [symbol] ( [symbol] ), ƒ_{D}(δ_{D}) and ƒ_{A}(δ_{A}), the reliability degree is calculated when the running temperature of the motor winding is lower than the certain temperature, that is, the running temperature of the motor winding t=tₐ+tₘ+Δt_{P}+Δt_{V}+ [symbol] +Δt_{D}+Δt_{A}, for a set motor winding temperature t₅, a subscript 5 of t₅ shows that five factors are considered, and a reliability degree P₅ is calculated when the running temperature of the motor winding t≤t₅;
two influence factors in the five factors are firstly composited, a probability P₂ is calculated, analysis is as follows: the random value range of a relative value of the first factor—motor power δ_{P} is [δ_{Pmin}, δ_{Pmax}], and the probability density function of the first factor motor power is ƒ_{P}(δ_{P}); at any point in a range [δ_{Pmin}, δ_{Pmax}] of an abscissa, a micro-component area ƒ_{P}(δ_{P})dδ_{P} with a micro width being dδ_{P} and a height being ƒ_{P}(δ_{P}) is taken, and the micro-component area is a probability when δ_{P} is valued therein;
a probability P₂ when tₐ+tₘ+Δt_{P}+Δt_{V}≤t₂ is solved, namely a sum of products of all micro area probabilities ƒ_{P}(δ_{P})dδ_{P} and a probability P₁ when tₐ+tₘ+Δt_{V}≤t₂−Δt_{P}=t₁, namely, P₂=∫_{δ}_{_{Pmin}}^{δ}^{_{Pmax}} P₁·ƒ_{P}(δ_{P})dδ_{P}, wherein a probability P₁ when Δt_{V}≤t₁−tₐ−tₘ, namely, δ_{V}≤(t₁−tₐ−tₘ)/K_{V}+1 is an area [symbol] _{V} of a figure on left side of the line δ_{V}=(t₁−tₐ−tₘ)/K_{V}+1 in FIG. 3, then P₂=∫_{δ}_{_{Pmin}}^{δ}^{_{Pmax}} [symbol] _{V}·ƒ_{P}(δ_{P})dδ_{P}, wherein [symbol] _{V}=∫_{δ}_{_{Vmin}}^{(t}^{₁}^{-t}^{ₐ}^{-t}^{ₘ}^{)/K}^{_{V}}⁺¹ ƒ_{V}(δ_{V})dδ_{V}; a [symbol] _{V} expression is substituted into the P₂ calculation formula, and a probability when the running temperature of the motor winding is lower than or equal to t₂ may be obtained;
recursive integrals continue to be deduced, the third factor, the fourth factor and the fifth factor are composited, and a probability P₅ when the running temperature of the motor winding is lower than or equal to t₅ is finally obtained:
P₅=∫_{δ}_{_{Amin}}^{δ}^{_{Amax}}∫_{δ}_{_{Dmin}}^{δ}^{_{Dmax}} [symbol] ∫_{δdi Pmin}^{δ}^{_{Pmax}}∫_{δ}_{_{Vmin}}^{(t}^{₁}^{-t}^{ₐ}^{-t}^{ₘ}^{)/K}^{_{V}}⁺¹ƒ_{V}(δ_{V})dδ_{V}ƒ_{P})(δ_{P})dδ_{P} [symbol] ( [symbol] )d [symbol] ƒ_{D}(δ_{D})dδ_{D}ƒ_{A}(δ_{A})dδ_{A} (28).

5. The prediction method for reliability degree of running temperature rise of a large and medium-sized motor according to claim 4, wherein in step G, the reliability degrees when the running temperature of the motor winding is lower than the given temperature under different environment temperatures are calculated and determined in a manner that according to recursive integrals in the formula (28), a program is compiled, a computer is used for different environment temperatures, progressive increasing is performed at a 0.2° C. winding running temperature step size for iterative calculation, the reliability degrees are solved when the running temperature of the motor winding is lower than or equal to given different temperatures, and a curve of an equal reliability degree is drawn.

6. The prediction method for reliability degree of running temperature rise of a large and medium-sized motor according to claim 5, wherein in step H, the calculation and determination method of the reliability degree of the running temperature rise of the motor winding is carried out in a manner that corresponding to the allowable highest temperature of the motor winding for a motor insulation grade, a horizontal line is drawn on a figure, intersection points of the horizontal line and curves of different equal reliability degrees are reliability degrees of the motor temperature rise under corresponding environment temperatures, and a relationship of the reliability degrees of the motor temperature rise and the environment temperatures is obtained by fitting the intersection points, and may be used for motor design, selection and running.
